(19) United States
(12) Patent Application Publication
(10) Pub. No.: US 2020/0033686 A1
(43) Pub. Date: Jan. 30, 2020

(54) ELECTROCHROMIC DEVICE AND METHOD OF DRIVING THE SAME, LENS UNIT, IMAGE PICKUP APPARATUS, AND WINDOW MEMBER

(71) Applicant: CANON KABUSHIKI KAISHA, Tokyo (JP)

(72) Inventor: Jun Yamamoto, Tokyo (JP)

(21) Appl. No.: 16/520,781

(22) Filed: Jul. 24, 2019

(30) Foreign Application Priority Data
Jul. 27, 2018 (JP) 2018-140883

(51) Int. Cl. G02F 1/1523; G02F 1/155; G02F 1/157; G02F 1/1516; B60R 1/08

(52) U.S. Cl. CPC G02F 1/1525; G02F 1/155; G02F 2001/1502; G02F 1/1516; B60R 1/088; G02F 1/157

(57) ABSTRACT

An electrochromic device including an electrochromic element with a complementary electrochromic layer containing an anodic organic electrochromic material and a cathodic organic electrochromic material, an optical density detection unit to detect the optical density of the electrochromic element, a temperature detection unit to detect the temperature of the electrochromic element, and a voltage supply unit to supply a drive voltage to the electrochromic element, the voltage supply unit being configured to apply a voltage of an opposite polarity to the electrochromic element based on the optical density of the electrochromic element detected by the optical density detection unit, and/or the temperature of the electrochromic element detected by the temperature detection unit, when the electrochromic element is to be decolored from a current optical density to a next target optical density.

### BACKGROUND

### Field of the Disclosure

The present disclosure generally relates to an electrochromic device using an electrochromic element and a method of driving the electrochromic device. The present disclosure also relates to a lens unit, an image pickup apparatus, and a window member each of which includes the electrochromic device.

### Description of the Related Art

A compound that is changed in optical characteristics such as absorption wavelength and absorbance for a substance by an electrochemical redox reaction is called “electrochromic (EC) compound”. An EC element utilizing the EC compound is applied, for example, to a display device, a variable reflectance mirror, and a variable transmission window.

EC elements formed of organic EC compounds include a “complementary” EC element including, as an EC layer, an EC solution containing an anodic organic EC material, which is colored by oxidation, and a cathodic organic EC material, which is colored by reduction. Such a complementary EC element is decolored by an electrode reaction, in which a wire between electrodes is short-circuited to rereduce cations and reoxidize anions, and by a self-decoloring reaction, in which cations and anions associate with each other are caused to disappear. In general, decoloration of the organic EC element is rate-determined by diffusion of the material, and hence decoloring response becomes faster as the element has a smaller gap between the electrodes and a shorter diffusion length.

Meanwhile, as the environment has a lower temperature, there is a problem in that the diffusion of the material becomes slower so that the decoloring response becomes slower, resulting in being required to consider an acceleration drive method.

In Japanese Patent Application Laid-Open No. 2014-098934 (hereinafter PTL 1), it is described, as a method of decoloring an organic EC element, to apply a voltage (reverse voltage) of a polarity opposite to a polarity of a voltage applied during driving for coloring, and then cause a short circuit between electrodes to increase decoloring responsiveness. During normal driving for maintaining a colored state, cations are generated in the vicinity of an anode, and anions are generated in the vicinity of a cathode. When the reverse voltage is applied from this state, the anode and the cathode are reversed, and hence anions are generated in the vicinity of the anode, and cations are generated in the vicinity of the cathode in the colored state. Therefore, it is considered that, in the vicinity of each of the anode and the cathode, the self-decoloring reaction between cations and anions is accelerated, and hence the decoloring responsiveness as an EC element is increased.

However, in the decoloration method of Japanese Patent Application Laid-Open No. 2014-098934, no technical idea for controlling the application of the reverse voltage is described.

A reverse voltage application time period has an optimal value depending on an optical density of the EC element.

Further, the balance of the self-decoloring reaction is significantly varied depending also on the optical density of the EC element and diffusibility, which depends on the temperature. Therefore, it is required that the optimal value of the reverse voltage application time period be selected depending on the optical density of the EC element and a temperature environment.

### SUMMARY

The present disclosure has an object to increase decoloring responsiveness irrespective of an optical density of the EC element and/or a temperature.

According to a first exemplary embodiment of the present disclosure, there is provided an electrochromic device including: an electrochromic element including a complementary electrochromic layer containing an anodic organic electrochromic material and a cathodic organic electrochromic material; an optical density detection unit configured to detect an optical density of the electrochromic element; a temperature detection unit configured to detect a temperature of the electrochromic element; and a voltage supply unit configured to supply a drive voltage to the electrochromic element, the voltage supply unit being configured to apply a voltage of an opposite polarity to the electrochromic element based on the optical density of the electrochromic element detected by the optical density detection unit, and/or the temperature of the electrochromic element detected by the temperature detection unit, when the electrochromic element is to be decolored from a current optical density to a next target optical density.

According to a second exemplary embodiment of the present disclosure, there is provided a lens unit including: an optical filter; and an image pickup optical system including a plurality of lenses, the optical filter being the electrochromic device in the present disclosure described above.

According to a third exemplary embodiment of the present disclosure, there is provided an image pickup apparatus including: an optical filter; an image pickup optical system including a plurality of lenses; and a light receiving element configured to receive light transmitted through the optical filter and the image pickup optical system, the optical filter being the electrochromic device in the present disclosure described above.

According to a fourth exemplary embodiment of the present disclosure, there is provided a window member including: a pair of substrates; and an electrochromic device disposed between the pair of transparent plates, the electrochromic device being the electrochromic device in the present disclosure described above.

Further features of the present disclosure will become apparent from the following description of exemplary embodiments with reference to the attached drawings.

### BRIEF DESCRIPTION OF THE DRAWINGS

FIG. 1A is a cross-sectional view for schematically illustrating a configuration of an EC element according to one embodiment.

FIG. 1B is a front view for schematically illustrating the configuration of the EC element according to the one embodiment.

FIG. 2A is a cross-sectional view for schematically illustrating a configuration of an EC element according to another embodiment.

FIG. 2B is a front view for schematically illustrating the configuration of the EC element according to another embodiment.

FIG. 3A is a graph for showing an example of an applied voltage waveform when the EC element of FIG. 1A and FIG. 1B is to be colored.

FIG. 3B is another graph for showing an example of the applied voltage waveform when the EC element illustrated in FIG. 1A and FIG. 1B is to be colored.

FIG. 4A is graphs for showing an example of applied voltage waveforms when the EC element of FIG. 2A and FIG. 2B is to be colored.

FIG. 4B is other graphs for showing an example of the applied voltage waveforms when the EC element of FIG. 2A and FIG. 2B is to be colored.

FIG. 5 is a block diagram for illustrating a configuration of an EC element according to one embodiment.

FIG. 6A is a cross-sectional view for schematically illustrating a configuration of an image pickup apparatus according to one embodiment.

FIG. 6B is another cross-sectional view for schematically illustrating a configuration of an image pickup apparatus according to another embodiment.

FIG. 7A is a perspective view for schematically illustrating a configuration of a window member according to one embodiment.

FIG. 7B is an end view for schematically illustrating the configuration of the window member according to the one embodiment.

FIG. 8 is a graph for showing density dependence of a reverse voltage application time period according to Example 1.

FIG. 9 is a graph for showing temperature dependence of the reverse voltage application time period according to Example 1.

FIG. 10 is a graph for showing profiles of decoloring response according to Example 2.

### DESCRIPTION OF THE EMBODIMENTS

Now, exemplary embodiments of an electrochromic device (EC device) and an electrochromic element 1 (EC element) used therein, and various apparatus including the EC device according to the present disclosure as a light control device are described as examples in detail with reference to the drawings. It should be noted, however, that configurations, relative arrangements, and the like described in those embodiments are not intended to limit the scope of the present disclosure unless otherwise specified.

<EC Element>

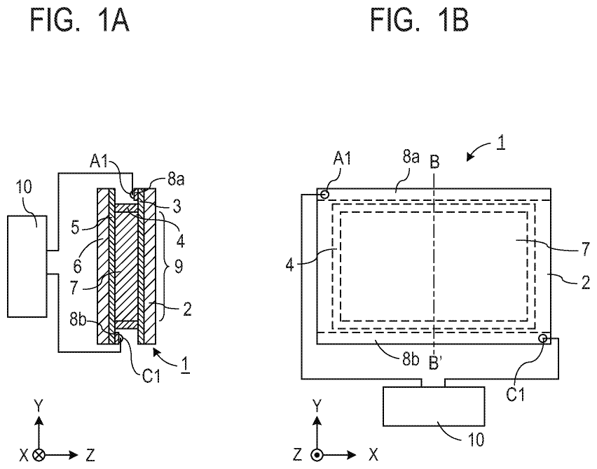

FIG. 1A and FIG. 1B are schematic views for illustrating a configuration of an EC element forming the EC device according to an embodiment of the present disclosure. FIG. 1A is an end view, FIG. 1B is a front view, and FIG. 1A is a view obtained by adding, to an end view of a cross section taken along the line B-B′ of FIG. 1B, power supply terminals A1 and C1, which are to be described later, and a connection form between the power supply terminals A1 and C1 and a voltage supply unit 10. The EC element in this example has a substantially rectangular external shape, with a long side direction of the EC element in the front view of FIG. 1B being defined as an X axis, a short side direction being defined as a Y axis, and a thickness direction orthogonal to the paper sheet being defined as a Z axis.

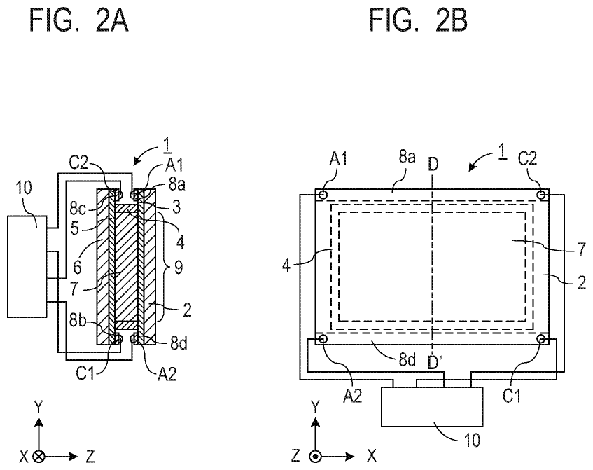

Similarly, FIG. 2A and FIG. 2B are schematic views for illustrating a configuration of the EC element according to another embodiment of the present disclosure. FIG. 2A is an end view, FIG. 2B is a front view, and FIG. 2A is a view obtained by adding, to an end view of a cross section taken along the line D-D′ of FIG. 2B, power supply terminals A1, A2, C1, and C2, which are to be described later, and a connection form between the power supply terminals A1, A2, C1, and C2 and the voltage supply unit 10. X, Y, and Z axes are defined as in FIG. 1A and FIG. 1B. In descriptions of the embodiments of FIG. 1A and FIG. 1B, and FIG. 2A and FIG. 2B, the Y-axis direction is defined as a vertical direction, and it is assumed that an EC element 1 is used while being held upright along the Y-axis direction.

The EC element 1 of FIG. 1A and FIG. 1B has the structure in which transparent substrates 2 and 6 having transparent electrodes 3 and 5 formed thereon are bonded together via a spacer 4 such that surfaces of the electrodes 3 and 5 are opposed to each other, and there is an electrochromic layer (EC layer) 7 in a gap formed by one pair of electrodes 3 and 5 and the spacer 4. An effective optical area 9 is an area of the EC layer 7, which is sandwiched between the electrodes 3 and 5, that exhibits a substantial optical effect in an apparatus using the EC element 1 as an optical member.

On the electrodes 3 and 5, low-resistance wirings 8a and 8b having resistance values that are smaller than the electrodes themselves are formed, and the low-resistance wirings 8a and 8b are arranged to be opposed to each other across the effective optical area 9 in the Y-axis direction. The power supply terminals A1 and C1 are formed to have contacts with the low-resistance wirings 8a and 8b, and are connected to the voltage supply unit 10 outside the EC element 1. A drive voltage is applied to the electrodes 3 and 5 by the voltage supply unit 10 via the power supply terminals A1 and C1 and the low-resistance wirings 8a and 8b. The voltage supply unit 10 is connected to a controller (not shown) configured to generate a drive voltage waveform, and is configured to apply a voltage between the power supply terminals A1 and C1 based on an instruction from the controller. It is preferred that the voltage supply unit 10 at least have a relay or switch circuit configured to invert a polarity between the power supply terminals A1 and C1, and the voltage supply unit 10 may further include a power supply, a regulator, and other such peripheral devices. The voltage supply unit 10 may further include circuitry configured to measure an electric current or electric charges generated in an electrochemical reaction.

Further, in the EC element 1 of FIG. 2A and FIG. 2B, low-resistance wirings 8a, 8b, 8c, and 8d are formed across the effective optical area 9 in the Y-axis direction on each of the electrodes 3 and 5, and the power supply terminals A1, A2, C1, and C2 are connected to the low-resistance wirings 8a, 8b, 8c, and 8d.

The EC layer 7 is a complementary EC layer containing one or more anodic organic electrochromic materials (organic EC materials) and one or more cathodic organic EC materials.

In the above-mentioned configuration, when a voltage is applied between the electrodes 3 and 5, the organic EC materials cause electrochemical reactions.

In general, the organic EC materials are in a neutral state under a state in which a voltage is not applied thereto, and do not show absorption in a visible light region. In such a decolored state, the EC element 1 exhibits the highest optical transmittance. When a voltage is applied between the electrodes 3 and 5, the EC layer 7 causes electrochemical reactions such that the anodic organic EC materials are converted from the neutral state to an oxidized state (cations), and the cathodic organic EC materials are converted to a reduced state (anions), with the result that the EC materials show absorption in the visible light region to be colored. In such a colored state, the EC element 1 exhibits a low optical transmittance.

In the following discussion, the optical transmittance of the EC element 1 is replaced with an optical density of the EC element 1. The optical transmittance and the optical density have a relationship of −log (transmittance)=(optical density). Every time the optical transmittance is reduced to ½, the optical density is increased by about 0.3.

(Substrate)

The substrates 2 and 6 are each preferably a transparent substrate configured to sufficiently transmit visible light. A grass material is generally used, and an optical glass substrate, such as Corning® #7059 or BK-7, may be preferably used. In addition, even a material such as plastic or ceramic may be appropriately used as long as the material has sufficient transparency. The substrates 2 and 6 are each preferably formed of a rigid material with less distortion. In addition, the substrates 2 and 6 each more preferably have less flexibility. In general, the substrates 2 and 6 each have a thickness of from several tens of micrometers to several millimeters.

(Electrode)

The electrodes 3 and 5 are each preferably a transparent electrode configured to sufficiently transmit visible light, and are each more preferably formed of a material having a high light transmitting property in a visible light region and high conductivity. Examples of a material for each of the electrodes 3 and 5 may include: metals and metal oxides, such as indium tin oxide alloy (ITO), tin oxide (NESA), indium zinc oxide (IZO), silver oxide, vanadium oxide, molybdenum oxide, gold, silver, platinum, copper, indium, and chromium; silicon-based materials, such as polycrystalline silicon and amorphous silicon; and carbon materials, such as carbon black, graphene, graphite, and glassy carbon. In addition, a conductive polymer having its conductivity improved through, for example, doping treatment (such as polyaniline, polypyrrole, polythiophene, polyacetylene, polyparaphenylene, or a complex of polyethylene dioxythiophene and polystyrene sulfonate (PEDOT:PSS)) is also suitably used. The EC element according to the present disclosure preferably has a high transmittance in a decolored state, and hence, for example, ITO, IZO, NESA, PEDOT:PSS, or graphene is particularly preferably used. Those materials may be used in various forms, such as a bulk form and a fine particle form. Those electrode materials may be used alone or in combination thereof.

(Ec Layer)

The EC layer 7 is preferably an EC layer in which an electrolyte and an organic EC material, such as a low-molecular weight organic material, are dissolved in a solvent.

The solvent is not particularly limited as long as the solvent can dissolve the electrolyte, but a polar solvent is particularly preferred. Specific examples thereof include water as well as organic polar solvents, such as methanol, ethanol, propylene carbonate, ethylene carbonate, dimethyl sulfoxide, dimethoxyethane, acetonitrile, γ-butyrolactone, γ-valerolactone, sulfolane, dimethylformamide, dimethoxyethane, tetrahydrofuran, acetonitrile, propionitrile, dimethylacetamide, methylpyrrolidinone, and dioxolane.

The electrolyte is not particularly limited as long as the electrolyte is an ion dissociative salt exhibiting satisfactory solubility and including a cation or anion having an electron-donating property to the extent that the coloration of the organic EC material can be ensured. Examples thereof include various inorganic ion salts, such as alkali metal salts and alkaline earth metal salts, quaternary ammonium salts, and cyclic quaternary ammonium salts. Specific examples thereof include: salts of alkali metals, such as Li, Na, and K, e.g., LiClO₄, LiSCN, LiBF₄, LiAsF₆, LiCF₃SO₃, LiPF₆, LiI, NaI, NaSCN, NaClO₄, NaBF₄, NaAsF₆, KSCN, and KCl; and quaternary ammonium salts and cyclic quaternary ammonium salts, such as (CH₃)₄NBF₄, (C₂H₅)₄NBF₄, (n-C₄H₉)₄NBF₄, (C₂H₅)₄NBr, (C₂H₅)₄NClO₄, and (n-C₄H₉)₄NClO₄. Generally known structures, such as ClO₄⁻, CF₃SO₃⁻, BF₄⁻, PF₆⁻, and (CF₃SO₂)₂N⁻, are used as anionic species. In addition, an ionic liquid may also be used. Those electrolyte materials may be used alone or in combination thereof.

Any material may be used as the organic EC material as long as the material has solubility in the solvent and can express coloration and decoloration through an electrochemical reaction. A known organic EC material to be colored through oxidation/reduction may be used. In addition, a plurality of such materials may be used in combination.

As described above, in the present disclosure, the anodic organic EC materials and the cathodic organic EC materials are used in combination as the organic EC materials. As each of the anodic organic EC materials and the cathodic organic EC materials, one kind may be used alone, or a plurality of kinds may be used.

Examples of the anodic organic EC material include: thiophene derivatives; metallocene derivatives, such as ferrocene; aromatic amine derivatives, such as a phenazine derivative, a triphenylamine derivative, a phenothiazine derivative, and a phenoxazine derivative; pyrrole derivatives; and pyrazoline derivatives. Examples of the cathodic organic EC material include a viologen-based compound, an anthraquinone-based compound, a ferrocenium salt-based compound, and a styrylated compound.

EC layer 7 is preferably a liquid or a gel. The EC layer 7 is suitably used in a solution state, but may also be used in a gel state as long as a speed of response is not significantly impaired. Gelling is carried out by further incorporating a polymer or a gelling agent into a solution. Examples of the polymer (gelling agent) include, but not particularly limited to, polyacrylonitrile, carboxymethylcellulose, polyvinyl chloride, polyvinyl bromide, polyethylene oxide, polypropylene oxide, polyurethane, polyacrylate, polymethacrylate, polyamide, polyacrylamide, polyester, polyvinylidene fluoride, and Nafion. Thus, the EC layer 7 may be used in a viscous state, a gel state, or the like.

In addition, the EC layer 7 may be used under a state in which the solution is supported by a structural body having a transparent and flexible network structure (for example, a sponge-like one), other than in the mixed state as described above.

(Low-Resistance Wiring)

The low-resistance wirings 8a and 8b are formed for the purpose of reducing an in-plane distribution of a voltage supplied from the power supply terminals A1 and C1 to the electrodes 3 and 5. When potential gradients are generated in planes of the electrodes 3 and 5 due to distances from the power supply terminals A1 and C1, unevenness in electrochemical reaction amount is caused in a plane of the EC element 1. The electrochemical reaction of organic EC materials is more likely to occur on the power supply terminal side with a higher potential. Therefore, when the EC element 1 is driven under a state of a large potential distribution, reaction of the anodic organic EC material is unevenly distributed on an anode power supply terminal (positive electrode) side, and reaction of the cathodic organic EC material is unevenly distributed on a cathode power supply terminal (negative electrode) side. As a result, segregation due to the effect of the potential distribution occurs. In order to reduce the potential distribution within the effective optical area 9 as much as possible, it is preferred for the power supply terminals A1 and C1 to be placed on the long-side side and at positions opposed to each other across the effective optical area 9. In the example of FIG. 1A and FIG. 1B, the A1 terminal is placed upward, and the C1 terminal is placed downward in the Y-axis direction.

Further, in order to suppress a potential drop in the long-side direction at this time to about 10 mV and thus suppress the segregation due to the potential distribution in the long-side direction, it is required for the low-resistance wirings 8a and 8b to be placed along the long sides. Surface resistances of the low-resistance wirings 8a and 8b are preferably less than 1/100th, and more preferably less than 1/500th of resistances of the electrodes 3 and 5. As each of the low-resistance wirings 8a and 8b, a thin-film silver wiring formed by vacuum deposition, or a thick-film silver wiring formed by screen printing or inkjet coating can be suitably used.

It should be noted, however, that, when the coloring operation is continued while only a pair of power supply terminals (for example, A1 terminal (anode) and C1 terminal (cathode)) are selected as in FIG. 1A and FIG. 1B, it is still difficult to avoid the segregation due to the effect of the potential distribution. In this case, the anodic organic EC materials are strongly colored in the vicinity of the A1 terminal and the low-resistance wiring 8a connected to the A1 terminal, and the cathodic organic EC materials are strongly colored in the vicinity of the C1 terminal and the low-resistance wiring 8b connected to the C1 terminal. The segregation due to the effect of the potential distribution tends to occur earlier and stronger than the segregation in the vertical direction due to the effect of specific gravities of the organic EC materials.

In order to avoid the segregation due to the potential distribution, the power supply terminals A2 and C2 are placed at positions opposed to the power supply terminals A1 and C1 across the effective optical area 9 as in FIG. 2A and FIG. 2B. Then, when the power supply terminals A1 and A2 are simultaneously used as anodes, and the power supply terminals C1 and C2 are simultaneously used as cathodes, the segregation due to the potential distribution can be avoided. Further, when voltage pulses of the same polarity are applied in turn between the A1 and C1 terminals and between the A2 and C2 terminals, the segregation due to the potential distribution can also be canceled.

<Method of Driving EC Element>

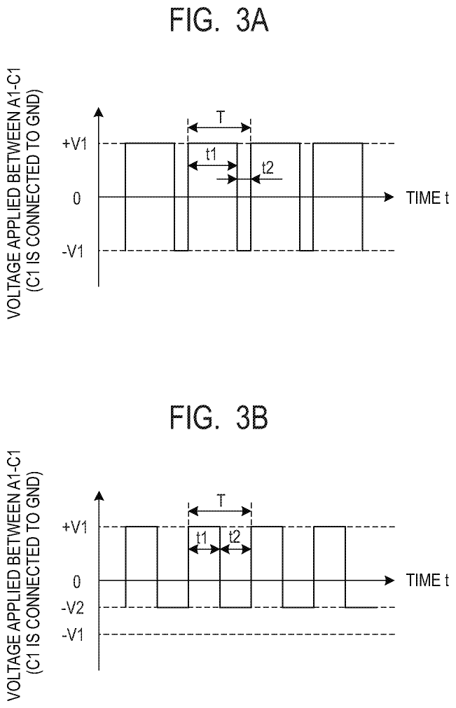

FIG. 3A and FIG. 3B are graphs for showing an applied voltage waveform in a case where the EC element 1 illustrated in FIG. 1A and FIG. 1B is driven while being held upright in the Y-axis direction, which is the vertical direction. In this Example, of the A1 terminal and the C1 terminal, the C1 terminal is connected to the ground, and hence applied voltages+V1 and −V1 express the polarity of the A1 terminal. The applied voltage +V1 causes an anodic reaction on the A1 terminal side and a cathodic reaction on the C1 terminal side, and hence causes coloring. In contrast, the applied voltage −V1 causes a cathodic reaction on the A1 terminal side and an anodic reaction on the C1 terminal side, and hence causes coloring.

When only the applied voltage −V1 is applied continuously as the applied voltage, the segregation due to the effect of the potential distribution occurs predominantly, with the result that anions are unevenly distributed on the A1 terminal side (upward in the vertical direction), and cations are unevenly distributed on the C1 terminal side (downward in the vertical direction). Further, the effect of the specific gravities is applied with a delay, with the result that the anions are moved upward in the vertical direction, and the cations are moved downward in the vertical direction, to thereby further increase the segregation with superimposition of both effects.

Meanwhile, when only the applied voltage +V1 is applied continuously as the applied voltage, the segregation due to the effect of the potential distribution causes cations to be unevenly distributed on the A1 terminal side, and anions to be unevenly distributed on the C1 terminal side. In addition, the effect of the specific gravities causes the anions to be moved upward in the vertical direction, and the cations to be moved downward in the vertical direction. When the cations and the anions collide with each other, a radical state returns to an initial state through exchange of electric charges to cause decoloring. Therefore, as compared to a case in which the applied voltage −V1 is applied continuously, the segregation of the organic EC materials in the vertical direction is reduced. However, with the segregation due to the effect of the potential distribution being predominant, as opposed to the case in which the applied voltage −V1 is applied, the cations are unevenly distributed upward in the vertical direction, and the anions are unevenly distributed downward in the vertical direction.

In the present disclosure, as illustrated in FIG. 3A, it is preferred that the applied voltages+V1 and −V1 be applied alternately, and time widths in which the applied voltages+V1 and −V1 are applied be controlled to adjust the segregation due to the effect of the potential distribution, and adjust cancellation by segregation due to the specific gravities. Specifically, an application time period t1 of the applied voltage +V1 and an application time period t2 of the applied voltage −V1 are defined as one cycle T, and a ratio between the time periods is controlled such that a reaction amount of the anodic organic EC material is controlled to become relatively larger than a reaction amount of the cathodic organic EC material on the A1 terminal side (upward in the vertical direction). Stated differently, the control is equivalent to controlling the reaction amount of the anodic organic EC material on the A1 terminal side (upward in the vertical direction) to become relatively larger than a reaction amount of the anodic organic EC material on the C1 terminal side (downward in the vertical direction).

Further, the reaction amounts of the organic EC materials can be estimated based on a charge amount measured by the electrochemical reaction. Further, the alternate application of the applied voltages+V1 and −V1 to the A1 terminal (upward in the vertical direction) and the C1 terminal (downward in the vertical direction) is equivalent to switching the power supply terminals provided upward in the vertical direction and downward in the vertical direction alternately to a positive electrode. Therefore, controlling the reaction amount of the anodic organic EC materials on the A1 terminal side (upward in the vertical direction) to become relatively larger than the reaction amount of the anodic organic EC materials on the C1 terminal side (downward in the vertical direction) corresponds to controlling an amount of charge generated when the power supply terminals provided upward in the vertical direction are used as positive electrodes to become larger than an amount of charge generated when the power supply terminals provided downward in the vertical direction are used as positive electrodes. The charge amount may be estimated by the voltage supply unit 10 measuring an electric current per unit time and calculating the charge amount based on summation of the electric currents.

Further, peak values of the voltages may be controlled as illustrated in FIG. 3B to adjust the segregation due to the effect of the potential distribution. In this case, for example, an applied voltage −V2, which is smaller in absolute value than the applied voltage −V1, is applied in the application time period t2. The reaction amounts of the electrochemical reaction depend on a magnitude of the drive voltage, and hence the applied voltages V1 and V2 are controlled to control the reaction amount of the anodic organic EC material to become relatively larger than the reaction amount of the cathodic organic EC material on the A1 terminal side (upward in the vertical direction).

Further, control can be performed suitably with both the time widths and the peak values of the voltages.

Further, when an optical density, that is, a gradation, of coloring of the EC element 1 is to be controlled, such adjustment can be made by adjusting the ratio between the time periods t1 and t2, adjusting a ratio between the applied voltages V1 and V2, or adjusting both the time widths and the peak values of the voltages. Alternatively, the adjustment can be made by a method of intermittently applying the applied voltage during the time period t1 or t2. When the application time periods t1 and t2 are long, the optical density of the EC element 1 fluctuates at timings of switching from the time period t1 to the time period t2, and from the time period t2 to the time period t1. Therefore, in order to suppress the change in optical density of the EC element 1 at the time when being driven to be colored, a time width of one cycle T is preferably 0.1 Hz or less, more preferably 1 Hz or less, and further preferably 10 Hz or less.

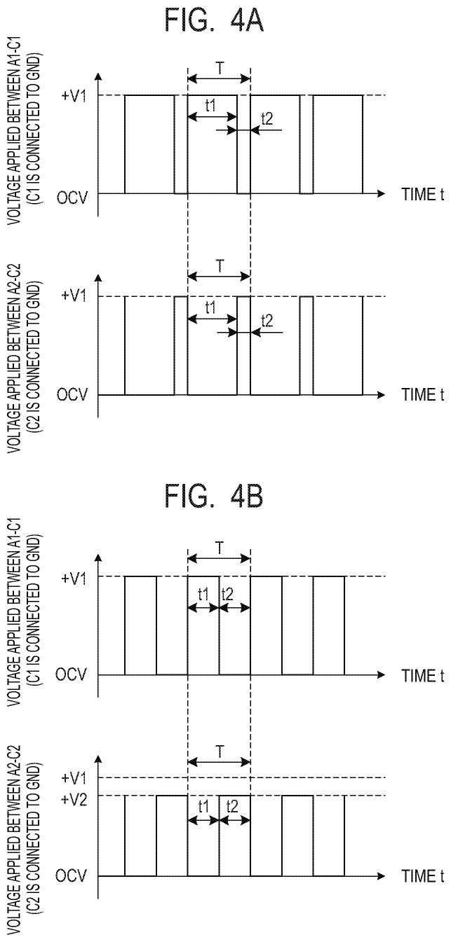

Next, in the EC element 1 of FIG. 2A and FIG. 2B, drive control methods in a case where the voltage pulses are applied sequentially between the A1-C1 terminals and between the A2-C2 terminals are described with reference to FIG. 4A and FIG. 4B.

FIG. 4A and FIG. 4B are graphs for showing applied voltage waveforms in a case where the EC element 1 illustrated in FIG. 2A and FIG. 2B is driven while being held upright in the Y-axis direction, which is the vertical direction. In FIG. 4A and FIG. 4B, the side of the A1 and C2 terminals is defined as upward in the vertical direction, and the side of the A2 and C1 terminals is defined as downward in the vertical direction. Of the A1 and C1 terminals, the C1 terminal is connected to the ground, and of the A2 and C2 terminals, the C2 terminal is connected to the ground. Therefore, an applied voltage +V1 means that a voltage of the same polarity is applied to the A1 and A2 terminals. In this example, as shown in FIG. 4A, voltage waveforms of opposite phases are applied between the A1 and C1 terminals and between the A2 and C2 terminals. A drive waveform between the A1-C1 terminals applies the voltage +V1 during the time period t1, and holds an open circuit voltage (Open Circuit Voltage, OCV) during the time period t2. Setting the open circuit voltage means breaking the electrical contact between a drive source side and the A1-C1 terminals, or inserting a high resistor to interrupt the electric current. Specifically, a switching element, for example, a relay or a transistor, is set to be conductive during the time period t1, and to be non-conductive during the time period t2. The coloring reaction occurs during the time period t1 in which the voltage +V1 is applied, and the coloring reaction does not occur during the time period t2 in which the OCV is held.

A voltage waveform of the opposite phase to that between the A1-C1 terminals is applied between the A2-C2 terminals, with the result that the OCV is held during the time period t1, and the voltage +V1 is applied during the time period t2. The voltage +V1 is applied alternately between the A1 and A2 terminals, with the result that the voltage applied on the EC element 1 does not drop, and the direction of the potential distribution is switched alternately, with the result that the segregation due to the effect of the potential distribution can be reduced. To describe more specifically, cations are generated on the A1 terminal side and anions are generated on the C1 terminal side during the time period t1, and cations are generated on the A2 terminal side and anions are generated on the C2 terminal side during the time period t2. Therefore, the cations and anions unevenly distributed between the A1 and C2 terminals are decolored through the exchange of electric charges, and the cations and anions unevenly distributed between the A2 and C1 terminals are similarly decolored through the exchange of electric charges. As a result, the segregation due to the effect of the potential distribution is further suppressed.

When the values of the time periods t1 and t2 are equal to each other, densities of the cations and anions generated between the A1 and C2 terminals and between the A2 and C1 terminals are closest to each other, and hence the segregation due to the effect of the potential distribution is most suppressed. However, when the effect of the specific gravities is added thereto, the cations and anions formed in the element plane are gradually moved, and eventually the cations are unevenly distributed upward in the vertical direction and the anions are unevenly distributed downward in the vertical direction.

In the drive control mode in the example, the time widths t1 and t2 are controlled as illustrated in FIG. 4A to adjust the segregation due to the effect of the potential distribution, and to adjust cancellation by the segregation due to the specific gravities. The EC element 1 is held upright in the vertical direction, and hence the A1 terminal is located above the A2 terminal in the vertical direction. The time width t1 of the coloring reaction on the A1 terminal side may be set relatively larger than the time width t2 of the coloring reaction on the A2 terminal side to control the uneven distribution of the cations due to the effect of the potential distribution to be predominant on the A1 terminal side.

Further, the peak values of the voltages may be controlled as illustrated in FIG. 4B to adjust the segregation due to the effect of the potential distribution of the A1 and A2 terminals. In this case, for example, a voltage +V2, which is smaller in absolute value than the voltage +V1, is applied in the application time period t2. The reaction amounts of the electrochemical reaction depend on the magnitude of the drive voltage, and hence the voltages V1 and V2 may be controlled to control the uneven distribution of the cations due to the effect of the potential distribution to be predominant on the A1 terminal side.

Further, control can be performed suitably with both the time widths and the peak values of the voltages.

Further, when the optical density, that is, the gradation, of coloring of the EC element 1 is to be controlled, such adjustment can be made by adjusting the ratio between the time periods t1 and t2, adjusting the ratio between the voltages V1 and V2, or adjusting both the time widths and the peak values of the voltages. Alternatively, the adjustment can be made by a method of intermittently applying the applied voltage during the time period t1 or t2.

When the application time periods t1 and t2 are long, the optical density of the EC element 1 fluctuates at timings of switching from the time period t1 to the time period t2, and from the time period t2 to the time period t1. Therefore, in order to suppress the change in optical density of the EC element 1 at the time when being driven to be colored, a time width of one cycle T is preferably 0.1 Hz or more, more preferably 1 Hz or more, and further preferably 10 Hz or more.

What is described in this example is to make, in the EC element 1 held upright in the vertical direction, a generation amount of cations that are generated on the side of the terminals located upward in the vertical direction relatively larger than a generation amount of cations that are generated on the side of the terminals located downward in the vertical direction. This is for the purpose of effectively using the segregation due to the effect of the potential distribution to cancel the segregation due to the effect of the specific gravities. This example has been described through use of the structures of the EC element 1 illustrated in FIG. 1A and FIG. 1B and FIG. 2A and FIG. 2B, and the drive control methods of FIG. 3A and FIG. 3B and FIG. 4A and FIG. 4B. However, any structure and drive control method that achieves a similar object can be deemed to satisfy the disclosure.

<Organic EC Device>

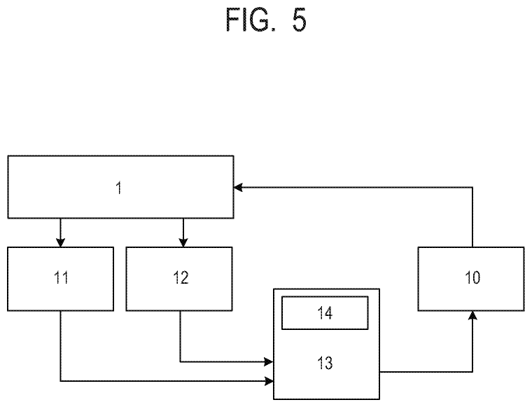

FIG. 5 is a block diagram for illustrating main components of the EC device according to the present disclosure.

The EC device according to the present disclosure at least includes the EC element 1, an optical density detection unit 11, a temperature detection unit 12, a controller 13, and the voltage supply unit 10. The optical density detection unit 11 is configured to detect the optical density of the EC element 1, the temperature detection unit 12 is configured to detect a temperature of the EC element 1, the controller 13 is configured to control driving of the EC element 1, and the voltage supply unit 10 is configured to supply the drive voltage to the EC element 1 in response to the instruction from the controller 13.

The voltage supply unit 10 is connected to the controller 13 configured to generate the drive voltage waveform, and is configured to control connection between the power supply and the A1 and C1 terminals (FIG. 1A and FIG. 1B) or the A1, A2, C1, and C2 terminals (FIG. 2A and FIG. 2B) of the EC element 1 based on the instruction from the controller 13 to apply the voltage between predetermined terminals.

The optical density detection unit 11 is disposed inside an active area (area in which the EC layer 7 is sandwiched by the electrodes 3 and 5 in FIG. 1A and FIG. 1B and FIG. 2A and FIG. 2B), in which coloring and decoloring reactions of the EC element 1 occur. It is more preferred that the optical density detection unit 11 be disposed inside the active area and outside the effective optical area 9. The optical density detection unit 11 includes the optical density detection unit 11 of the EC element 1, and is configured to pass acquired data on the optical density to the controller 13. In regard to the above-mentioned function, the configuration of the optical density detection unit 11 is not limited in particular, and a suitable example includes a configuration in which a light projection unit, for example, an LED, and a light receiving unit, for example, a photodiode, are combined with each other.

The temperature detection unit 12 is configured to detect the temperature of the EC element 1, and pass acquired data on the temperature to the controller 13. The configuration of the temperature detection unit 12 is not limited in particular as long as the temperature of the EC element 1 can be detected, and a suitable example includes a configuration including various thermocouples as sensors for detection.

The controller 13 has a function of a microcomputer including a CPU and a memory, and is configured to control drive control instructions for the EC element 1. The controller 13 is configured to determine and change a pattern of a drive waveform depending on a control sequence for coloring the EC element 1, maintaining the colored state, decoloring, and the like, and issue a predetermined instruction to the voltage supply unit 10. Specifically, the controller 13 is configured to determine control on a voltage to be applied during coloring, an application time width (duty ratio in PWM driving) of the voltage, and voltage control during decoloring, for example. The controller 13 is also configured to issue an instruction to acquire data to the optical density detection unit 11 and the temperature detection unit 12, and receive data acquired from those detection units.

Further, in the present disclosure, the controller 13 includes a data unit 14 configured to provide a reverse voltage application time period, which is required when the EC element 1 is to be decolored.

The data unit 14 is referenced from the controller 13 when the EC element 1 is to be decolored. The data unit 14 has acquired in advance a relationship between application time for a reverse voltage at a given optical density and a given temperature of the EC element 1 and total decoloration time (that is, sum of reverse voltage time and short-circuit time) that has been taken for decoloring response when the EC element 1 was short-circuited after the reverse voltage is applied.

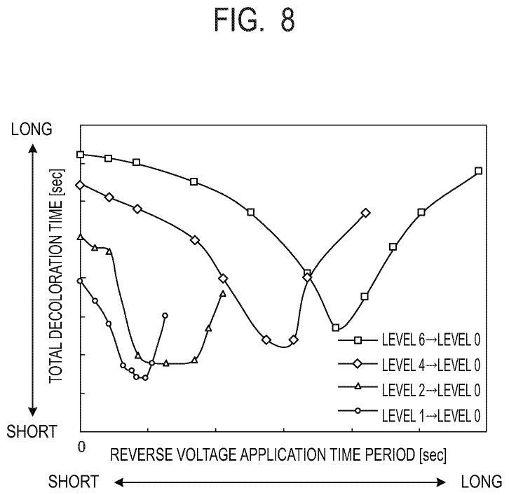

For example, the reverse voltage application time period at the given temperature and optical density dependence of the total decoloration time included in the data unit 14 are shown in FIG. 8, as described later in Example 1. When the reverse voltage application time period is too short, densities of materials of opposite polarities generated in the vicinity of the anode and the cathode are low, and hence sufficient effect on the increase in decoloring responsiveness cannot be obtained. In contrast, when the application time of the reverse voltage is too long, densities of materials of opposite polarities are too high, with the result that a self-decoloring reaction becomes unbalanced, and that the decoloring responsiveness becomes slower on the contrary. Further, the balance of the self-decoloring reaction is changed depending also on the optical density and diffusibility (that is, temperature) of the EC element 1, and hence as the optical density becomes higher, it is required to induce more materials of opposite polarities. Therefore, as shown in FIG. 8, the reverse voltage application time period has an optimal value depending on the optical density of the EC element 1. When the temperature is the same, as the optical density becomes higher, the optimal value of the reverse voltage application time period becomes larger.

Similarly, a reverse voltage application time period at an optical density and temperature dependence of the total decoloration time also have optimal values depending on the temperature. When the optical density is the same, as the temperature becomes lower, the optimal value of the reverse voltage application time period becomes larger.

The data unit 14 may include, as a calibration curve, the temperature dependence of the optimal value of the reverse voltage application time period at the given optical density or the optical density dependence of the optimal value of the reverse voltage time at the given temperature described above. Alternatively, the data unit 14 may include a matrix-like table of the optical density, the temperature, and the optimal value of the reverse voltage application time period acquired based on the above-mentioned relationship. The optical density and the temperature to be acquired may have any resolutions, but a resolution that is equal to or finer than 45° C. in the case of the temperature and a resolution that is equal to or finer than A1 stop (minimum unit of gradation) in the case of the optical density are preferred.

It is preferred that the reverse voltage application time period that can be adopted at the given optical density and the given temperature be the optimal value of the reverse voltage application time period. However, any time can be selected in a range having the effect of increasing the decoloring responsiveness as compared with the total decoloration time in the case where reverse voltage driving application time is 0 seconds (that is, only short circuit). However, that an advantage of adopting time longer than the optimal value of the reverse voltage application time period is small, and it is preferred to adopt the optimal value of the reverse voltage application time period or a range shorter than the optimal value.

The controller 13 is configured to control the voltage supply unit 10 so as to apply the reverse voltage to the EC element 1 during the reverse voltage application time period acquired from the data unit 14, and then control the voltage supply unit 10 so as to maintain the EC element 1 at a target optical density. The controller 13 is configured to perform, when it is desired to maintain the EC element 1 in the decolored state, control so that a short circuit is caused between the electrodes 3 and 5 after the reverse voltage is applied.

<Drive Method for Decoloring EC Element>

In the configuration of the EC device illustrated in FIG. 5, driving for decoloring the EC element 1 is performed as follows. Connection of the terminals is not particularly limited as long as similar control can be performed.

When the EC element 1 is changed from a current optical density to a next target optical density in a decoloration direction, the controller 13 acquires the current optical density from the optical density detection unit 11, and a current element temperature from the temperature detection unit 12. The acquisition may be performed once immediately before a decoloration instruction, or may be performed in periodic sampling irrespective of the decoloration instruction.

The controller 13 refers to the data unit 14 based on the acquired optical density and temperature to acquire a required reverse voltage application time period from the calibration curve or the table generated based on the optical density, the temperature, and the optimal value of the reverse voltage time, which have been acquired in advance.

The controller 13 transmits a voltage control pattern, that is, the reverse voltage application time period and the drive voltage after the reverse voltage application time period to the voltage supply unit 10 so as to control the EC element 1 in the decoloration direction.

The voltage supply unit 10 controls to change the connection between the power supply and the A1 and C1 terminals or the A1, A2, C1, and C2 terminals of the EC element 1 from the colored state so that the reverse voltage is applied between the terminals A1 and C1 (FIG. 1A and FIG. 1B), or between the terminals A1 and C1 and between the terminals A2 and C2 (FIG. 2A and FIG. 2B) of the EC element 1. The reverse voltage may be applied as a constant value, or may be controlled to be gradually reduced in the application time. As a waveform of the gradual reduction, a step shape, a straight line shape, a curve shape, or the like may be suitably selected, but it is preferred that the waveform conform to the method of acquiring the calibration curve or the table included in the data unit 14.

After the reverse voltage application time period instructed by the controller 13 has been elapsed, the voltage supply unit 10 controls the connection between the power supply and the terminals so as to maintain the next target optical density. When it is desired to maintain the EC element 1 in the decolored state, a short-circuit state is maintained between the A1 and C1 terminals or among the A1, A2, C1, and C2 terminals. Further, when it is desired to maintain another optical density, the connection between the power supply and the terminals is changed again to the colored state.

According to the present disclosure, in the driving for decoloring the EC element through use of the application of the reverse voltage, the decoloring responsiveness can be increased regardless of the optical density and the temperature of the EC element.

<Application to Various Apparatus>

The EC device according to the present disclosure can be used not only as an optical filter in a lens unit or an image pickup apparatus, but also in a window member.

[Optical Filter]

The EC device according to the present disclosure may be used as an optical filter in an image pickup apparatus, for example, a camera, and when used in the image pickup apparatus, the EC device may be disposed in an image pickup apparatus main body or in a lens unit. Now, a case in which a neutral density (ND) filter is formed as the optical filter is described.

It is required that the neutral density filter exhibit even light absorption in a visible light range. In order to achieve the ND filter using the organic EC materials, it is preferred that a plurality of materials having different absorption wavelength range in the visible light range be mixed to even absorption intensities in the visible light range. An absorption spectrum obtained when the organic EC materials are mixed is expressed by a sum of absorption spectra of the materials, and hence even light absorption can be achieved by selecting a plurality of materials having an appropriate wavelength range and adjusting densities thereof.

In a case of low-molecular weight organic EC materials, a wavelength range that can be covered by one material is generally 100 nm to 200 nm. In order to cover the entire visible light range of 380 nm to 750 nm, it is preferred to use at least three or more kinds of organic EC materials. For example, it is preferred to use, as the organic EC materials, three or more kinds of anodic organic EC materials, three or more kinds of cathodic organic EC materials, or two or more kinds of anodic organic EC materials and two or more kinds of cathodic organic EC materials.

In order to reduce the intensity of light to ½ to 1/64 as the ND filter, it is sufficient that an amount of change of the optical density may be controlled to 0 to 1.8 in steps of 0.3.

[Lens Unit And Image Pickup Apparatus]

A lens unit according to the present disclosure includes the above-mentioned optical filter and an image pickup optical system including a plurality of lenses. The optical filter may be arranged so that light that has passed through the optical filter passes through the image pickup optical system, or so that light that has passed the image pickup optical system passes through the optical filter.

Further, the image pickup apparatus according to the present disclosure includes the above-mentioned optical filter according to the present disclosure and a light receiving element configured to receive light that has passed through the optical filter.

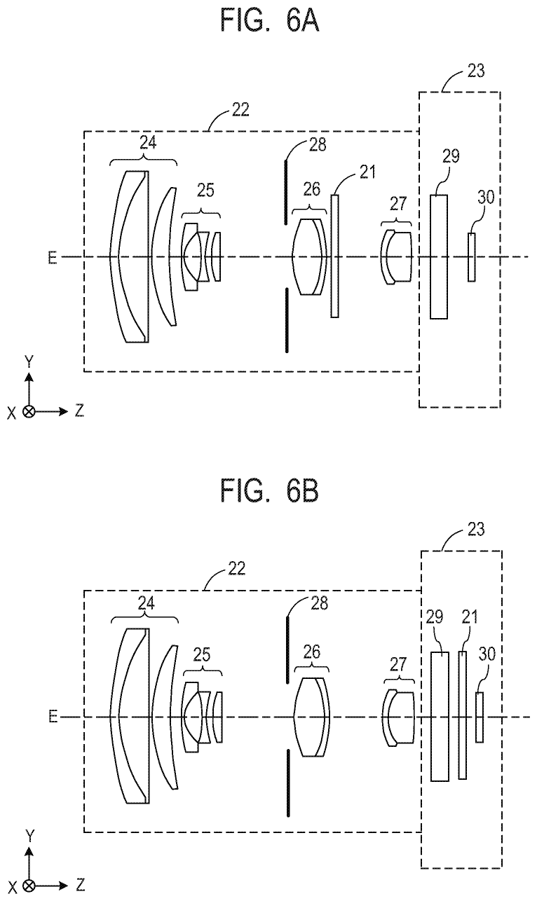

Configurations of a lens unit and an image pickup apparatus using the EC device according to the present disclosure as an optical filter are described with reference to FIG. 6A and FIG. 6B. FIG. 6A is a view for illustrating a configuration in which a lens unit 22 includes an optical filter 21, and FIG. 6B is a view for illustrating a configuration in which an image pickup apparatus 23 includes the optical filter 21. As illustrated in FIG. 6A and FIG. 6B, the lens unit 22 is removably connected to the image pickup apparatus 23 via a mount member (not shown).

The lens unit 22 is a unit including a plurality of lenses or lens groups. For example, the lens unit 22 illustrated in FIG. 6A is a rear-focus-type zoom lens in which focusing is performed after an aperture stop 28. The lens unit 22 includes the following lens groups in order from an object side (left side as seen from the front of the drawing sheet): a first lens group 24 having a positive refractive power, a second lens group 25 having a negative refractive power, a third lens group 26 having a positive refractive power, and a fourth lens group 27 having a positive refractive power. An interval between the second lens group 25 and the third lens group 26 is changed to vary the magnification, and a partial lens group of the fourth lens group 27 is moved for focusing. The lens groups 24 to 27 have a center axis E in FIG. 6A.

The lens unit 22 includes the aperture stop 28 between the second lens group 25 and the third lens group 26, and the optical filter 21 between the third lens group 26 and the fourth lens group 27, for example. This arrangement allows light passing through the lens unit 22 to pass through the lens groups 24 to 27, the aperture stop 28, and the optical filter 21, and an amount of light can be adjusted with the use of the aperture stop 28 and the optical filter 21. The configuration other than the optical filter 21 is the image pickup optical system according to the present disclosure.

Further, the configuration inside the lens unit 22 can be changed as appropriate. For example, the optical filter 21 can be arranged before (on the object side of) or after (on the image pickup apparatus 23 side of) the aperture stop 28, and may be arranged before the first lens group 24 or after the fourth lens group 27. When the optical filter 21 is arranged at a position at which light is converged, there can be obtained an advantage that an area of the optical filter 21 can be reduced. Further, a form of the lens unit 22 can also be selected as appropriate, and instead of the rear focus type, an inner focus type in which focusing is performed before the stop may be adopted, or another type may be adopted. Further, instead of the zoom lens, a special lens, for example, a fisheye lens or a macro lens, can be selected as appropriate.

A glass block 29 included in the image pickup apparatus 23 is a glass block, for example, a low-pass filter, a face plate, or a color filter. Further, a light receiving element 30 is a sensor unit configured to receive light that has passed through the lens unit 22, and an image pickup element, for example, a CCD or a CMOS can be used. Further, the light receiving element 30 may be an optical sensor, for example, a photodiode, and an optical sensor configured to acquire and output information on an intensity or a wavelength of the light can be used as appropriate.

As illustrated in FIG. 6A, when the optical filter 21 is incorporated in the lens unit 22, some components, such as a drive power supply, of the voltage supply unit 10 of FIG. 5 may be arranged inside the lens unit 22, or outside the lens unit 22. When arranged outside the lens unit 22, the components are connected to the optical filter 21 inside the lens unit 22 via a wiring to perform drive control.

As illustrated in FIG. 6B, the image pickup apparatus 23 itself may include the optical filter 21. The optical filter 21 may be arranged at an appropriate spot inside the image pickup apparatus 23, and the light receiving element 30 may be arranged to receive light that has passed through the optical filter 21. In FIG. 6B, for example, the optical filter 21 is arranged immediately before the light receiving element 30. When the image pickup apparatus 23 itself includes the optical filter 21, it is not required for the lens unit 22 itself, which is connected thereto, to include the optical filter 21, and hence an image pickup apparatus 23 using an existing lens unit and being capable of controlling light can be configured.

The above-mentioned image pickup apparatus can be applied to a product including a combination of light amount adjustment and the light receiving element. For example, the image pickup apparatus can be used in a camera, a digital camera, a video camera, or a digital video camera, and is also applicable to a product including an image pickup apparatus, for example, a cell phone, a smart phone, a PC, or a tablet.

[Window Member]

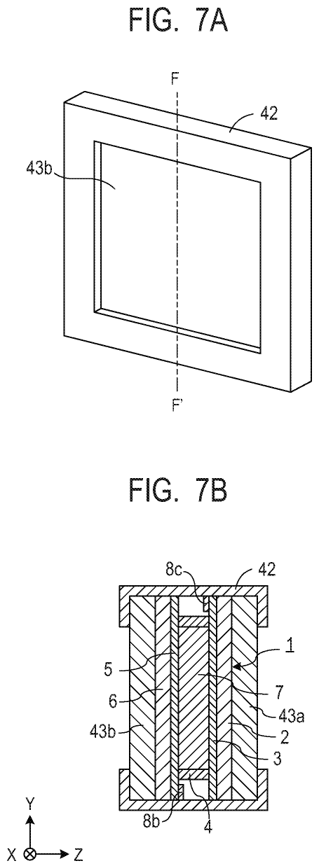

A window member according to the present disclosure is described with reference to FIG. 7A and FIG. 7B. FIG. 7A is a view for illustrating a configuration of a window member according to one embodiment of the present disclosure, FIG. 7A is a perspective view, and FIG. 7B is an end view of a cross section taken along the line F-F′ of FIG. 7A.

The window member in this example is a light control window configured to adjust a transmission amount of incident light, and is formed by sandwiching the EC device according to the present disclosure between a pair of transparent plates. In the embodiment of FIG. 7A and FIG. 7B, the window member includes the EC element 1 illustrated in FIG. 1A and FIG. 1B, transparent plates 43a and 43b between which the EC element 1 is sandwiched, and a frame 42 configured to surround and integrate the whole. The controller 13 and the voltage supply unit 10 illustrated in FIG. 5 may be integrated inside the frame 42, or may be arranged outside the frame 42 and connected to the EC element 1 via a wiring.

The transparent plates 43a and 43b are not particularly limited as long as a material thereof has a high optical transmittance, and it is preferred that the transparent plates 43a and 43b be made of a glass material in consideration of the use as a window. In the present disclosure, the EC element 1 and the transparent plates 43a and 43b are made of different components. However, the present disclosure is not limited thereto, and the transparent substrates 2 and 6 of the EC element 1 may be used as the transparent plates 43a and 43b, for example.

The frame 42 is not limited in material, and members that cover at least a part of the EC element 1 and have an integrated form as a whole may be regarded as a frame.

The window member according to the present disclosure can be applied to a use of adjusting an amount of sunlight entering a room during the day, for example. In addition to the amount of sunlight, the window member can be applied also to adjustment of an amount of heat, and hence can be used for controlling a brightness and a temperature in the room. Further, the window member can also be applied as a shutter to a use of blocking a view from outside to inside a room. The above-mentioned window member may be applied not only to a glass window for a building, but also to a window of a vehicle, for example, a car, a train, a plane, or a ship, or a filter of a display surface of a watch or a cell phone.

### Example 1

Effects of driving for decoloring with the reverse voltage in a case of using the EC element 1 illustrated in FIG. 1A and FIG. 1B were measured. The EC element 1 used in Example 1 of the present disclosure was prepared as follows.

ITO transparent electrodes (electrodes 3 and 5) having a sheet resistance of 10Ω/□ were formed on glass substrates (substrates 2 and 6) each having a thickness of 0.7 mm to form electrode substrates. The EC element 1 in Example 1 has a rectangular element external shape, and hence the low-resistance wirings 8a and 8b were formed along long sides of the EC element 1. As the low-resistance wirings 8a and 8b, thick silver films having a sheet resistance of 6.6 mΩ/□ (film thickness of 5 μm) were formed by screen printing with the use of silver nanoparticle paste.

Gap control particles (diameter: 50 μm) and a thermo-curable epoxy resin were mixed, and a sealing pattern having an opening for injecting an EC solution was drawn and applied on an electrode of one electrode substrate by a dispenser device. Subsequently, the one electrode substrate was bonded to the other electrode substrate so that the electrodes are opposed to each other to prepare an empty cell having an electrode gap of 50 μm. The gap control particles and the thermo-curable epoxy resin correspond to the spacer 4.

Next, as the EC solution, a solution was prepared by dissolving an anodic organic EC material, a cathodic organic EC material, and polymethylmethacrylate (PMMA) as a thickener in a propylene carbonate solvent. A phenazine compound expressed by the following structural formula (1) was used as the anodic organic EC material, and a bipyridinium salt compound expressed by the following structural formula (2) was used as the cathodic organic EC material. A concentration of each of the anodic organic EC material and the cathodic organic EC material was 100 mM, and a load of PMMA was 10 mass % with respect to the solvent.

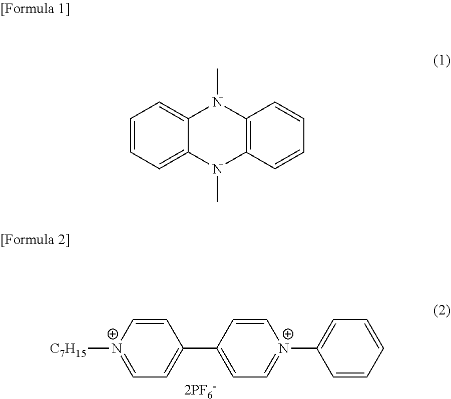

In a cell prepared to leave the opening that has been prepared in advance, the above-mentioned EC solution was filled by a vacuum injection method to seal the opening with a UV-curable epoxy resin. Further, leads were soldered to the low-resistance wirings 8a and 8b to prepare the EC element 1 having the A1 terminal and the C1 terminal, and the EC element 1 was arranged while being held upright so that the A1 terminal side is directed upward in the vertical direction. An electrochemical measurement device capable of setting a drive sequence was used as the controller 13 and the voltage supply unit 10 to control the coloring and decoloring of the above-mentioned EC element 1. For the measurement of the optical density of the EC element 1, an LED and a photodiode were used in combination. The EC element 1, the LED, and the photodiode were installed in a chamber of an environment tester, and the EC element 1 was driven under a given temperature environment.

In FIG. 8, the reverse voltage application time period at −5° C. and the optical density dependence of the total decoloration time are described in Example 1. After control was performed so that the optical density was colored to each level, a reverse voltage of −1.0 V was applied for a given time period, and then a short circuit was caused. In Example 1, the optical density was evenly divided into six stops between the highest optical density and the lowest optical density of the EC element 1 to control display with seven gradation levels.

In a case where the optical density was decolored from Level 6 to Level 0, when the reverse voltage application time period was shifted, the total decoloration time was gradually reduced, exhibited the minimum, and was increased again. In this manner, in decoloration at the given temperature and from the given optical density, the reverse voltage application time period had the optimal value. Further, under the given temperature, the optimal value of the reverse voltage application time period was changed depending on the optical density, and as the optical density became higher, the optimal value became larger, and the total decoloration time also became longer.

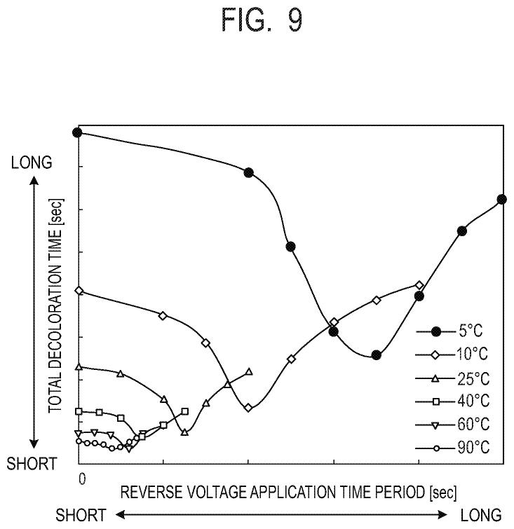

In FIG. 9, the reverse voltage application time period at the optical density of Level 6 and the temperature dependence of the total decoloration time are described in Example 1. Under each temperature, control was performed so that the optical density was colored to Level 6, the reverse voltage of −1.0 V was applied for a given time period, and then a short circuit was caused.

In a case where the optical density was decolored from Level 6 to Level 0 at −5° C., when the reverse voltage application time period was shifted, the total decoloration time was gradually reduced, exhibited the minimum, and was increased again. In this manner, in decoloration at the given optical density and from the given temperature, the reverse voltage application time period had the optimal value. Further, under the given optical density, the optimal value of the reverse voltage application time period was changed depending on the temperature, and as the temperature became lower, the optimal value became larger, and the total decoloration time also became longer.

In the EC device according to the present disclosure, by acquiring those relationships in advance, storing those relationship as the data unit 14, and referencing the data unit 14, the decoloring responsiveness of the EC element 1 can be increased irrespective of the optical density and the temperature.

### Example 2

In Example 2 of the present disclosure, in driving for decoloring with the reverse voltage, effects of performing control so that the reverse voltage is gradually reduced in the application time were measured. The EC element 1 used in Example 2 was prepared as in Example 1.

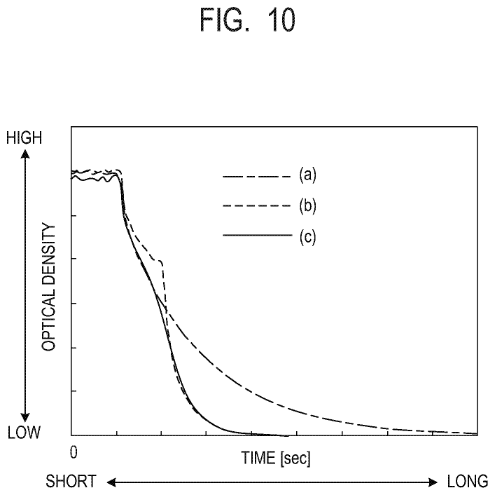

FIG. 10 is a graph for showing profiles of decoloring response in Example 2. The EC element 1 was decolored from the optical density of Level 6 under the environment of 40° C. The one-dot chain line (a) in FIG. 10 indicates a profile of decoloring response obtained when the reverse voltage time was set to 0 seconds (only short circuit), and the broken line (b) indicates a profile of decoloring response obtained when the reverse voltage of −1.0 V was applied for a certain time. Further, the solid line (c) indicates a profile of decoloring response obtained when the control was performed so that the reverse voltage of −1.0 V was gradually reduced toward 0 V in a straight line. In the lines (b) and (c), the application time of the reverse voltage was adjusted to choose the fastest total decoloration time.

In the lines (b) and (c) obtained by applying the reverse voltage, the decoloring responsiveness is increased as compared to the line (a). In the line (b) obtained by applying the reverse voltage being the constant voltage, a large fluctuation is shown in two steps in the profile. Such fluctuation in optical density in the decoloration step may give a sense of discomfort to a user, but in the line (c), the fluctuation in profile is suppressed, and the effect of increasing the responsiveness by the reverse voltage control is obtained more advantageously.

According to the present disclosure, an appropriate reverse voltage application time period is selected depending on the optical density and the temperature of the EC element, and hence the light control device with increased decoloring responsiveness can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2018-140883, filed on Jul. 27, 2018, which is hereby incorporated by reference herein in its entirety.

What is claimed is:

1. An electrochromic device comprising:
an electrochromic element including a first electrode, a second electrode, and an electrochromic layer disposed between the first electrode and the second electrode;
an optical density detection unit configured to detect an optical density of the electrochromic element;
and
a voltage supply unit configured to supply a drive voltage to the electrochromic element to increase the optical density of the electrochromic device, and to supply a reverse voltage of an opposite polarity to the electrochromic element to reduce the optical density of the electrochromic device, based on the optical density of the electrochromic element detected by the optical density detection unit.

2. The electrochromic device according to claim 1, wherein the voltage supply unit determines a reverse voltage application time period, which is a time period for applying the reverse voltage of the opposite polarity, based on the optical density detected by the optical density detection unit.

3. The electrochromic device according to claim 1, wherein the voltage supply unit includes a data unit, and the data unit includes a calibration curve or a table obtained by determining, in advance, reverse voltage application time periods for a given optical density of the electrochromic element.

4. The electrochromic device according to claim 1, further comprising a temperature detection unit configured to detect a temperature of the electrochromic element;

5. The electrochromic device according to claim 4, wherein the voltage supply unit determines a reverse voltage application time period, which is a time period for applying the reverse voltage of the opposite polarity, based on the optical density detected by the optical density detection unit and the temperature of the electrochromic element detected by the temperature detection unit.

6. The electrochromic device according to claim 4, wherein the voltage supply unit includes a data unit, and the data unit includes a calibration curve or a table obtained by determining, in advance, a relationship of reverse voltage application time periods at a given temperature of the electrochromic element, and total decoloration time required for decoloring response after the reverse voltage is applied to the electrochromic element.

7. The electrochromic device according to claim 4, wherein the voltage supply unit includes a data unit, and the data unit includes a calibration curve or a table obtained by determining, in advance, relationships among a reverse voltage application time period at a given optical density of the electrochromic element, a reverse voltage application time period at a given temperature of the electrochromic element, and total decoloration time required for decoloring response after the reverse voltage is applied to the electrochromic element.

8. The electrochromic device according to claim 1, wherein the reverse voltage has a polarity opposite to the polarity lowering the optical transmittance of the electrochromic element.

9. An electrochromic device comprising:
an electrochromic element including a first electrode, a second electrode, and an electrochromic layer disposed between the first electrode and the second electrode;
a temperature detection unit configured to detect a temperature of the electrochromic element; and
a voltage supply unit configured to supply a drive voltage to the electrochromic element,
the voltage supply unit applying to the electrochromic device a voltage of an opposite polarity based on the temperature of the electrochromic element detected by the temperature detection unit.

10. The electrochromic device according to claim 9, wherein the voltage supply unit determines a reverse voltage application time period, which is a time period for applying the voltage of the opposite polarity, based on the temperature detected by the temperature detection unit.

11. The electrochromic device according to claim 9, wherein the voltage supply unit includes a data unit, and the data unit includes a calibration curve or a table obtained by determining, in advance, a relationship among reverse voltage application time periods at a given temperature of the electrochromic element.

12. The electrochromic device according to claim 1, wherein the electrochromic layer includes an anodic organic electrochromic material and a cathodic organic electrochromic material.

13. An image pickup apparatus comprising:
an optical filter;
an image pickup optical system including a plurality of lenses; and
a light receiving element configured to receive light transmitted through the optical filter and the image pickup optical system,
the optical filter including the electrochromic device of claim 1.

14. A window member comprising:
a pair of substrates; and
an electrochromic device disposed between the pair of transparent plates, the electrochromic device including the electrochromic device of claim 1.

15. A method of driving an electrochromic device,
the electrochromic device including:
an electrochromic element including a first electrode, a second electrode, and an electrochromic layer disposed between the first electrode and the second electrode;
an optical density detection unit configured to detect an optical density of the electrochromic element;
and
a voltage supply unit configured to supply a drive voltage to the electrochromic element,
the method comprising applying, by the voltage supply unit, a voltage of an opposite polarity to the electrochromic element based on the optical density of the electrochromic element detected by the optical density detection unit.

16. The method of driving an electrochromic device according to claim 15, further comprising determining a reverse voltage application time period based on the optical density detected by the optical density detection unit.

17. The method of driving an electrochromic device according to claim 15, the device further comprising a temperature detection unit configured to detect a temperature of the electrochromic element;
the electrochromic element being applied the voltage of the opposite polarity based on the optical density of the electrochromic element detected by the optical density detection unit and the temperature of the electrochromic element detected by the temperature detection unit.

18. The method of driving an electrochromic device according to claim 15, wherein the reverse voltage application time period is obtained by referring to a data unit included in the voltage supply unit.

19. The method of driving an electrochromic device according to claim 15, wherein the voltage of the opposite polarity is gradually reduced.

20. The method of driving an electrochromic device according to claim 15, wherein the reverse voltage application time period is obtained by referring to a data unit included in the voltage supply unit.
